(19) United States
(12) Patent Application Publication
(10) Pub. No.: US 2013/0111939 A1
(43) Pub. Date: May 9, 2013

(54) METHOD AND DEVICE FOR DECREASING MOISTURE IN A GAS IN A HOUSING INTERIOR

(71) Applicant: Xiaofeng Yan, Weinstadt (DE)

(72) Inventor: Xiaofeng Yan, Weinstadt (DE)

(73) Assignee: Robert Bosch GmbH, Stuttgart (DE)

(21) Appl. No.: 13/516,386

(22) PCT Filed: Oct. 28, 2010
(86) PCT No.: PCT/EP2010/066325

§ 371 Date: Aug. 31, 2012

(30) Foreign Application Priority Data
Dec. 18, 2009 (DE) 10 2009 054 922.6

(51) Int. Cl. F17D 3/00; F25D 21/14; B67D 99/00

(52) U.S. Cl. CPC F17D 3/00; B67D 99/00; F25D 21/14
USPC 62/282; 137/2; 137/154

(57) ABSTRACT

A method and a device for decreasing moisture in a gas in a housing interior, in particular in a battery housing interior, include a gas having a lower proportion of water vapor than the gas in the housing interior. The gas having the lower proportion of water vapor is generated by a drying device and introduced into the housing interior. The method and the device further include a gas being discharged out of the housing interior such that the housing interior is at least partially filled with the gas having the lower proportion of water vapor.

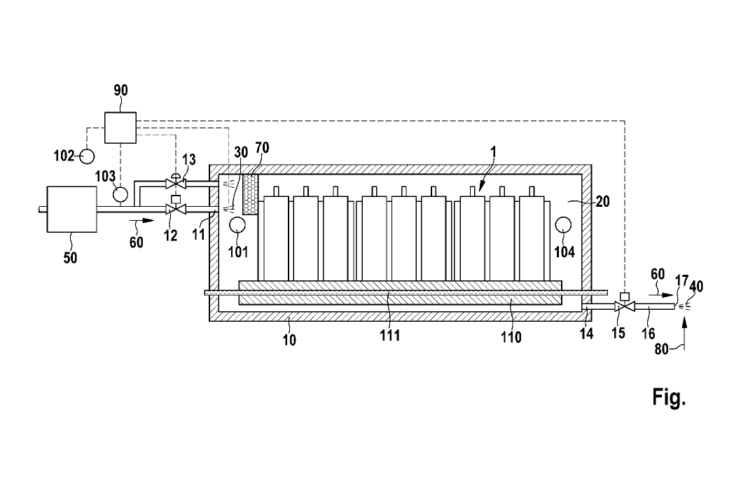

The present invention relates to a method for decreasing moisture in a gas in a housing interior, in particular in a battery housing interior, and to a device for decreasing moisture in a housing interior of an energy storage system.

The method and the device are preferably used for decreasing moisture in housing interiors in which battery cells or batteries are arranged. Battery cells and batteries comprising battery cells form, in a known manner, one or more rechargeable batteries, which can be electrically charged and discharged again. In this case, a battery cell is a single galvanic cell which produces a characteristic voltage, depending on the combination of materials of the electrodes in the cell. The battery cells can be connected in series or in parallel with one another to form a battery.

### PRIOR ART

In particular lithium-ion batteries have been used to an increased extent in recent times in cellular telephones, laptops and other portable electronic devices. In addition, the use of lithium-ion batteries as energy stores in electric-drive motor vehicles is ever increasing. In order to ensure sufficient operation reliability and provision of power, the lithium-ion batteries in this case need to be operated within an optimum temperature range, for which reason one or more cooling systems for cooling the batteries are often arranged in the direct vicinity of the batteries. These cooling systems are generally likewise arranged in a housing surrounding the batteries or battery cells. The housing performs the function of fixing the batteries, protecting the seal of said batteries with respect to the environment and providing thermal and electrical insulation for said batteries. In addition, power electronics and electrical lines for controlling the batteries during the charging and discharging operation are normally arranged in the battery housing, in addition to the battery modules and the cooling system in the form of a thermal management system. Such electronic control means are relatively sensitive to pressure fluctuations, with the result that the battery housing in which the control device is accommodated needs to have a pressure compensation valve. This pressure compensation valve opens when a critical pressure difference value is exceeded. That is to say that the housing is open with respect to the ambient air under certain conditions and therefore it is possible for exchange to take place between the gas enclosed in the housing and the external air, with the result that the ingress of moisture contained in the ambient air into the housing cannot be avoided. In the event of temperature fluctuations, condensation processes may therefore result, in particular in the event of activation of the cooling system within the housing, with the result that water condensation is formed which can result in short circuits and/or corrosion.

The invention is therefore based on the object of providing a method and a device by means of which the moisture in a gas accommodated in the housing interior can be kept below a critical value in a simple and reliable manner, in particular with pressure compensation.

This object is achieved by the method according to the invention as claimed in claim 1 and by the device according to the invention as claimed in claim 5. Advantageous configurations of the method are specified in dependent claims 2 to 4, and advantageous configurations of the device according to the invention are specified in dependent claims 6 to 10.

### DISCLOSURE OF THE INVENTION

According to the invention, a method is provided for decreasing the moisture in a gas in a housing interior, in particular in a battery housing interior, in which a gas with a lower water vapor content than the gas in the housing interior is produced by means of a drying device and introduced into the housing interior and a gas is passed out of the housing interior, with the result that the housing interior is at least partially filled with the gas with the lower water vapor content. In this case, the gas which is accommodated in the housing prior to the gas with the reduced water vapor content being introduced is usually air. The method according to the invention is not restricted to the introduction and discharge of pure gases, but gases can also be understood to mean gas mixtures within the context of the invention. The gas with the lower water vapor content is preferably produced outside the housing interior. In this case, for example, external air can be supplied to the drying device and subjected to a drying process, with the result that the gas in the drying device has a lower water vapor content than the external air at this time. Then, the dried gas is passed into the housing interior, with said gas being mixed with the gas in the housing interior, with the result that the gas mixture produced in the housing interior has a lower water vapor content than the gas previously contained in the housing and/or the dried gas displaces the gas previously located in the housing interior, with the result that the relatively dry gas fills the housing. In order to avoid a positive pressure, gas is discharged from the housing, with this discharged gas either being the gas previously accommodated in the housing or a mixture of this gas previously contained in the housing and the dried gas which has been introduced. The method therefore serves to decrease the moisture in particular in battery housings in which lithium-ion rechargeable batteries are arranged, which are used as energy source for dried purposes.

The method according to the invention can therefore be configured in such a way that the gas produced with a lower water vapor content is accommodated in the housing in place of the gas previously contained in the housing interior. Therefore, the gas passed out of the housing is the gas which previously filled the housing. Once the gas previously contained in the housing has been passed out, now only the gas with the reduced water vapor content is located in the housing.

Alternatively or in combination with the displacement of the gas originally contained in the housing by the gas with the lower water vapor content, provision can be made for the gas with the lower water vapor content to at least partially mix with the gas contained in the housing interior. Therefore, the gas passed out of the housing is a gas mixture comprising the gas originally contained in the housing and the gas with the reduced water vapor content. The gas now contained in the housing likewise has a lower water vapor content than the water vapor content of the gas originally contained in the housing owing to the mixing.

In a preferred configuration of the method, provision is made for the gas to be passed out of the housing interior and a negative pressure induced thereby to be formed in the housing interior and caused by this, gas with a lower water vapor content to be introduced owing to the effect of a negative pressure at a housing output, the negative pressure being produced by gas flow, in particular ambient air flow, at an opening connected to the housing output. In a preferred use of the device for drying the air or the gas in a battery housing of a motor vehicle, an opening which is connected to the housing outlet, for example by means of a line, can be arranged on the underbody, in the rear region or on the tailgate of the motor vehicle, for example. Owing to the airstream flowing past the opening, a negative pressure is produced at the opening owing to the injection principle, and this causes the gas to be passed out of the opening region and therefore also out of the housing outlet and the housing itself. A suction effect for realizing the flow of dry gas through the housing can thus be brought about without the arrangement of a pump.

According to the invention, also provided is a device for decreasing moisture in a housing interior, in particular in a battery housing interior, which comprises a drying device for reducing the water vapor content in a gas, the drying device being connectable or connected to the housing interior by means of at least one line in such a way that the gas dried by the drying device can be introduced into the housing interior. In this case, provision can be made for the drying device to already be arranged fixedly on the housing and for the housing thus to be part of the device or for the drying device to be provided separately and merely to be configured in such a way that it can be connected to a connection provided for this purpose on the housing. The dried gas provided by the drying device has, in its composition, a lower water vapor content than the gas from which it was produced by means of drying. In order to introduce the dried gas into the housing, the device can comprise a pump. This pump can be arranged between the drying device and the housing or else at a housing outlet for discharging gas from the housing so as to avoid a positive pressure. The drying device preferably comprises a cooling element or a cooling unit, which may be configured as a bypass of a cooling device arranged in the battery housing for cooling the battery cells. Via cooling of external air, for example, condensation of moisture contained in this external air and deposition of the water condensation thus produced is realized by means of the drying device. This results in a relatively dry gas which is introduced into the housing in accordance with the invention.

In order to further reduce the moisture in the housing interior, provision can be made for the device to comprise a desiccant, which is arranged downstream of the drying device in the gas flow direction in such a way that the gas dried by the drying device can flow through said desiccant. This desiccant can be silicone, for example. After a certain use duration, the desiccant needs to be replaced, with it being possible to detect the optimum replacement time by means of a sensor arranged on or in the desiccant.

In addition to the sensor for detecting the moisture in the desiccant, the device can comprise at least one first sensor for detecting the water vapor content of the gas in the housing interior and/or at least one second sensor for detecting the water vapor content of the ambient air surrounding the housing and/or at least one third sensor for detecting the water vapor content of the gas produced by the drying device. The mentioned sensors are in this case connected to an open-loop and closed-loop control unit for evaluating the signals generated by the sensors and for generating corresponding signals for the open-loop and/or closed-loop control of the flow through the housing interior.

In addition or as an alternative, the device can comprise at least one leakage sensor for detecting a gas leak from the housing interior. It is possible by means of this leakage sensor to establish how great the proportion of ambient air flowing into the housing per unit time is in order to introduce dried air into the housing correspondingly and as appropriate for the humidity of the ambient air. The determined leakage rate has a considerable influence on the throughflow intervals to be set. The mentioned leakage sensor is also connected to the open-loop and closed-loop control unit.

Advantageously, the device comprises at least one pressure compensation valve which is connected to the housing interior, the pressure compensation valve being designed in such a way that it can perform the function of an actuating element for influencing the volume flow of gas with the reduced water vapor content into the housing interior.

In a preferred configuration, provision is made for the drying device contained in the device to have an air conditioning unit, by means of which ambient air can be taken up, for it to be possible for heat to be extracted from the taken-up ambient air and for the taken-up ambient air to thus be cooled and condensate produced in the process to be separated from the taken-up ambient air. The dry or dried air thus produced is introduced into the housing interior in accordance with the invention. The air conditioning unit can in this case be configured in such a way that the dry air is heated again. The air conditioning unit can in this case be part of or a piece of equipment for a motor vehicle, in particular when using the device according to the invention and the method according to the invention for drying the gas in a battery housing of a battery which is used for driving the motor vehicle.

Such an air conditioning unit functions on the basis of the “reheat” principle, wherein the external air first flows through an evaporator, the heat is extracted from the external air by means of coolant and the external air is thus cooled to almost 0° C. Owing to the sudden reduction in temperature, the gaseous water vapor condenses in the external air to give liquid water and is separated off by a water separator. The dry air can then be heated to the temperature set by a user again via a heat exchanger.

The device according to the invention is therefore preferably based on drying of external air which is provided outside the battery pack. The device comprises a system for producing dry air from external air, namely the drying device, and an air guidance system for supplying dry air and dissipating moist housing interior air with at least in each case one controllable valve on the inlet and outlet sides. In addition, the pressure compensation valve is preferably connected to the air feed line. The device according to the invention preferably comprises sensors for moisture monitoring and a closed-loop and open-loop control unit.

The dry air can also be provided via a closeable component, such as a flap control mechanism, for example, wherein, in the application of an air conditioning unit, for example an air conditioning unit of a motor vehicle, the flap control mechanism closes in the circulating-air mode and ensures that relatively moist motor-vehicle internal air in the circulating-air mode does not pass into the feed line of the air guidance system.

In addition, the device can comprise temperature sensors for determining ambient and battery temperatures, the determined temperatures being used as output signals in the open-loop or closed-loop control process in order to implement the flushing process in optimum fashion. If the temperature in the housing interior is higher than an ambient temperature, it is possible to check whether flushing is initiated directly with external air when it can be assumed that the external air is drier than the gas accommodated in the housing interior. A differential pressure sensor, which can likewise be detected by the device, serves to determine pressure differences between the surrounding environment and the battery housing interior, wherein the closed-loop and open-loop control unit receives a measurement signal from the differential pressure sensor which is a carrier of the information regarding when the pressure compensation valve is open and closed. Therefore, the closed-loop and open-loop control unit can detect what volume of external air has passed into the housing.

The air guidance system likewise advantageously contained in the device ensures that the dry air is supplied from the drying device to the battery housing interior and the gas previously accommodated in the housing interior is passed out of said housing interior. The pressure compensation valve is connected to the feed line preferably in such a way that, in the case of pressure compensation, on valve opening only dry air can pass into the housing interior. This measure guarantees that the housing interior air remains dry for a longer period of time and extends the interval between flushings with dry air. Preferably, inlets and outlets are arranged as parts of the air guidance system on the housing in such a way that the inner structures of the battery arrangement are taken into consideration, namely by virtue of inlet and outlet ideally being arranged diagonally with respect to one another, as a result of which a so-called “air short circuit”, i.e. a direct flow on the shortest path from the inlet to the outlet, without any flow circulating around further components or with poor circulation of flow with regions without any flow relationships, can be avoided. In this case, the invention is not restricted to the arrangement of only one inlet and one outlet, rather it is possible for a plurality of inlets and outlets, which can be arranged parallel or in series, to be arranged on the housing.

The method for flushing the battery housing is preferably implemented at regular time intervals, in particular in the morning and in the evening, namely when different temperature conditions are present inside and outside the housing. In addition, the flushing should preferably be performed at the beginning of a journey and at the end of a journey of a motor vehicle provided with the device and in dependence on the leak rate of the battery housing and the external temperature. The aim here is to avoid a critical moisture value in the housing interior above which a hazardous level of water condensation formation can arise. In general, air from the circulating-air mode of an air conditioning unit of the motor vehicle should not be used for flushing the housing, since said air can have a relatively high moisture level owing to respiration and transpiration of the occupants, with the result that sufficient drying of this gas is not ensured under certain conditions. In a particular configuration, when the gas accommodated in the housing is sucked away owing to a negative pressure, an inlet-side control valve can be replaced by the pressure compensation valve, in particular when the pressure compensation valve is electrically actuable and drivable. In this case, the outlet valve is the triggering actuator. When the outlet valve is opened, the housing interior pressure is reduced and a pressure difference is produced, which in turn results in the pressure compensation valve being opened. The closed-loop and open-loop control unit does not need to merely coordinate the throughflow so as to achieve sufficient drying, in this case, but also needs to control the pressure compensation. The detection of the pressure in the housing interior can be performed by means of the differential pressure sensor. The open-loop and closed-loop control unit can possibly be configured in such a way that it resets the air conditioning unit to fresh-air mode in the case of a need for drying in the housing interior and when the circulating-air mode of the air conditioning unit has been set, in order thus to avoid a flow of circulating air into the battery housing.

The invention will be explained below with reference to the attached drawings.

In this case, the single figure shows a battery in a sectional view from the side with the drying device connected.

The figure shows a battery 1, which is formed from a plurality of battery cells which are electrically conductively connected to one another. The battery 1 is located in a substantially closed housing 10. In this case, the battery 1 is positioned on a cooling system 110, which is equipped with a cooling medium line 111 for the throughflow of cooling medium for the purpose of optimum cooling. An inlet valve 12, which is fluidically connected to a drying device 50, is connected to a housing inlet 11. The pressure compensation valve 13 is arranged in a bypass to the inlet valve 12 and is thus likewise connected to the housing interior. On the opposite side, the housing 10 has a housing outlet 14, at which an outlet valve 15 is arranged. A line 16 which has an opening 17 connected to the housing outlet adjoins the outlet valve 15. In addition to the battery 1 and the cooling system 110, gas 20 is located in the interior of the housing 10. Gas, for example external air, is taken up by the drying device 50 and dried in the described manner. The dried gas 30 is guided into the housing 1 via the inlet valve 13 and the housing inlet 11 in the gas flow direction 60. In this case, said gas can flow through a desiccant 70, as illustrated in the figure, as a result of which the water vapor content in the dried gas 30 is decreased further still. In the housing interior, the dried gas 30 mixes with the gas in the housing 20 and/or displaces this gas 20 through the housing outlet and the outlet valve 15 into the surrounding environment. As a result, a positive pressure in the housing 1 is avoided.

The inlet valve 12, the pressure compensation valve 13 and the outlet valve 15 are connected to a closed-loop and open-loop control unit 90, which serves to control or regulate the valves for the purpose of opening and closing. The closed-loop and open-loop control unit 90 is also connected to a first sensor for detecting the water vapor content of the gas in the housing 101, to a second sensor for detecting the water vapor content of the ambient air 102 surrounding the housing and/or to a third sensor for detecting the water vapor content of the gas 103 produced by the drying device and possibly to a leakage sensor 104. In each case one corresponding signal relating to the water vapor content of a respective gas in the housing and/or in the ambient air and/or in the gas flow downstream of the drying device can be supplied to the closed-loop and open-loop control unit 90 by means of the first to third sensors, wherein the closed-loop and open-loop control unit 90 evaluates the corresponding signals and uses them to control or regulate the valves.

The housing 10 or the opening 17 connected to the housing outlet can be arranged in such a way that, when using the device according to the invention in a motor vehicle, an ambient air flow 80 at this opening 17 brings about a negative pressure which acts via the outlet valve 15 as far as into the housing interior and therefore causes the gas in the housing 20 to be passed out. The pressure compensation valve 13 in turn opens automatically or as a result of an open-loop or closed-loop control signal from the closed-loop and open-loop control unit 90, with the result that gas dried by the drying device or, given corresponding dryness of the ambient air, ambient air is supplied to the housing interior. It is therefore possible to realize without dry air flowing through the housing without the use of an energy-consuming pump.

1. A method for decreasing moisture in a gas in a housing interior, comprising:
producing a gas with a lower water vapor content than the gas in the housing interior with a drying device,
introducing the gas with the lower water vapor content into the housing interior, and
passing a gas out of the housing interior so that the housing interior is at least partially filled with the gas with the lower water vapor content.

2. The method for decreasing moisture as claimed in claim 1, wherein the gas with the lower water vapor content at least partially displaces the gas previously contained in the housing interior.

3. The method for decreasing moisture as claimed in claim 1, wherein the gas with the lower vapor content is at least partially mixed with the gas contained in the housing interior.

4. The method for decreasing moisture as claimed in claim 1, wherein the passing of the gas out of the housing interior induces the formation of a negative pressure in the housing interior, and wherein the gas with the lower water vapor content is introduced owing to the effect of a negative pressure at a housing output, the negative pressure being produced by gas flow at an opening connected to the housing output.

5. A device for decreasing moisture in a housing interior, comprising:
a drying device configured to reduce the water vapor content in a gas, the drying device being connectable or connected to the housing interior by at least one line in such a way that the gas dried by the drying device is introduced into the housing interior.

6. The device for decreasing moisture as claimed in claim 5, further comprising a desiccant which is arranged downstream of the drying device in a gas flow direction in such a way that the gas dried by the drying device flows through said desiccant.

7. The device for decreasing moisture as claimed in claim 5, further comprising one or more of at least one first sensor configured to detect the water vapor content of the gas in the housing interior and at least one second sensor configured to detect the water vapor content of the ambient air surrounding the housing and at least one third sensor configured to detect the water vapor content of the gas produced by the drying device.

8. The device for decreasing moisture as claimed in claim 5, further comprising at least one leakage sensor configured to detect a gas leak from the housing interior.

9. The device for decreasing moisture as claimed in claim 5, further comprising at least one pressure compensation valve connected to the housing interior, the pressure compensation valve being configured in such a way that the valve performs the function of an actuating element configured to influence the volume flow of gas with a reduced water vapor content into the housing interior.

10. The device for decreasing moisture as claimed in claim 5, wherein the drying device comprises an air conditioning unit, the air conditioning unit being configured to take up ambient air, extract heat from the taken up ambient air and cool the taken up ambient air, and separate condensate produced by the extraction of heat from and the cooling of the taken up ambient air.

11. The method for decreasing moisture as claimed in claim 1, wherein the housing interior is a battery housing interior.

12. The method for decreasing moisture as claimed in claim 4, wherein the gas flow at the opening is ambient air flow.

13. The device for decreasing moisture as claimed in claim 5, wherein the housing interior is a battery housing interior.
